(19) United States
(12) Patent Application Publication
(10) Pub. No.: US 2006/0142973 A1
(43) Pub. Date: Jun. 29, 2006

(54) Field equipment management system

(75) Inventor: Isao Hirooka, Tokyo (JP)

Correspondence Address: EDWARDS & ANGELL, LLP, P.O. BOX 55874, BOSTON, MA, 02205, US

(73) Assignee: Yokogawa Electric Corporation, Tokyo (JP)

(21) Appl. No.: 11/312,844

(22) Filed: Dec. 19, 2005

(30) Foreign Application Priority Data
Dec. 28, 2004 (JP) 2004-379715

(51) Int. Cl. G21C 17/00

(52) U.S. Cl. 702/183

(57) ABSTRACT

A field equipment managing system comprises a field equipment, a data collecting section for collecting a parameter of the field equipment at a predetermined period, a field equipment database for storing the collected parameter, and a diagnosing section for conducting a diagnosis of the field equipment by using the stored parameter.

This application claims foreign priority based on Japanese Patent application No. 2004-379715, filed Dec. 28, 2004, the contents of which is incorporated herein by reference in its entirety.

### BACKGROUND OF THE INVENTION

1. Field of the Invention

The present invention relates to a field equipment management system for integrally managing a field equipment.

2. Description of the Related Art

In a plant, a factory, etc., a management system employing a computer in instrumentation and control is set up, and a life cycle cost during operation is suppressed to a minimum. This management system is started from a centralized system using a central computer in the past, then shifted to a distributed system with the advent of a microprocessor, and then developed into an integrated system that can be used in the right place, which is a present system. Since the recent integrated system is equipped with intelligent field equipments, various control management functions, and digitally communicable field buses, such integrated system can grasp field information promptly and is useful in plant management.

The field equipment for supporting a digital communication such as FF-1, HART, Profibus holds a number of parameters in the inside thereof. A failure of the field equipment can be predicted by diagnosing a change of the value of a particular parameter among these parameters.

FIG. 2 is a configurative view of a field equipment management system in a related art.

In a case of diagnosing a field equipment 1, parameters of the field equipment 1 are collected only while the diagnosis is conducted in response to a request issued from a diagnosing section 2. Then, the status of the field equipment 1 is analyzed by checking the values of the parameters.

Here, only the field equipment 1 is shown, however, the number of the field equipments is not limited to one.

As the configuration of the field equipment management system in the related art, for example, there is a management system described in JP-A-2003-186529.

However, following problems lay in the related art in FIG. 2.

Since the parameters of the field equipment are collected only while the diagnosis of the field equipment is conducted, the change of the past parameter values can not be grasped.

Also, it is difficult to determine the correlation with a history of a past failure of the same type equipment, a history of an alarm in a process, and the like, statistically and integrally so as to diagnose the field equipment, only based on the parameters collected at the time of diagnosis.

### SUMMARY OF THE INVENTION

It is an object of the present invention to realize a field equipment management system capable of conducting a diagnosis of a field equipment with high reliability, by collecting a parameter of a designated field equipment continuously at a predetermined period, and utilizing the collected parameter.

According to an aspect of the invention, a field equipment managing system comprises a field equipment; a data collecting section for collecting a parameter of the field equipment at a predetermined period; a field equipment database for storing the collected parameter; and a diagnosing section for conducting a diagnosis of the field equipment by using the stored parameter.

According to the aspect of the invention, the field equipment managing system further comprises a controller for controlling the field equipment, wherein the data collecting section starts collecting the parameter when the controller recognizes the field equipment.

According to the aspect of the invention, in the field equipment managing system, the data collecting section stops collecting the parameter when the field equipment becomes unrecognized by the controller.

According to the aspect of the invention, the field equipment managing system further comprises a storing section for storing a collecting parameter defining file which designates the parameter to be collected, wherein the data collecting section collects the parameter based on the collecting parameter defining file.

According to the aspect of the invention, the field equipment managing system further comprises a collecting parameter setting section, wherein the collecting parameter setting section designates the parameter to be collected by the data collecting section, for every field equipment.

According to the aspect of the invention, the field equipment managing system further comprises a collecting parameter setting section, wherein the collecting parameter setting section designates the period of collecting the parameter by the data collecting section, for every parameter.

According to the aspect of the invention, the field equipment managing system further comprises a controller for controlling the field equipment, wherein the controller issues at least any one of an instruction to start collecting the parameter and an instruction to stop collecting the parameter, to the data collecting section.

According to the aspect of the invention, in the field equipment managing system, the field equipment database stores an individual identifier of the field equipment and a logical identifier of the field equipment, in association with the parameter.

According to the aspect of the invention, in the field equipment managing system, when the field equipment is replaced with another field equipment, the diagnosing section selects to handle the parameter of the field equipment before the replacement and the parameter of the field equipment after the replacement as the parameters from the same field equipments or from the different field equipments.

According to the aspect of the invention, in the field equipment managing system, the diagnosing section acquires at least any one of a history of a failure of the field equipment and a history of an alarm in a process from the controller, correlates the parameter stored in the field equipment database with the acquired history, and conducts the diagnosis of the field equipment based on the acquired history and the correlated parameter.

According to the aspect of the invention, in the field equipment managing system, the diagnosing section conducts a failure prediction of the field equipment.

### BRIEF DESCRIPTION OF THE DRAWINGS

FIG. 1 is a configurative view showing an embodiment of the invention.

FIG. 2 is a configurative view of a field equipment management system in a related art.

### DESCRIPTION OF THE PRFERRED EMBODIMENTS

The present invention will be explained in detail with reference to the drawing hereinafter.

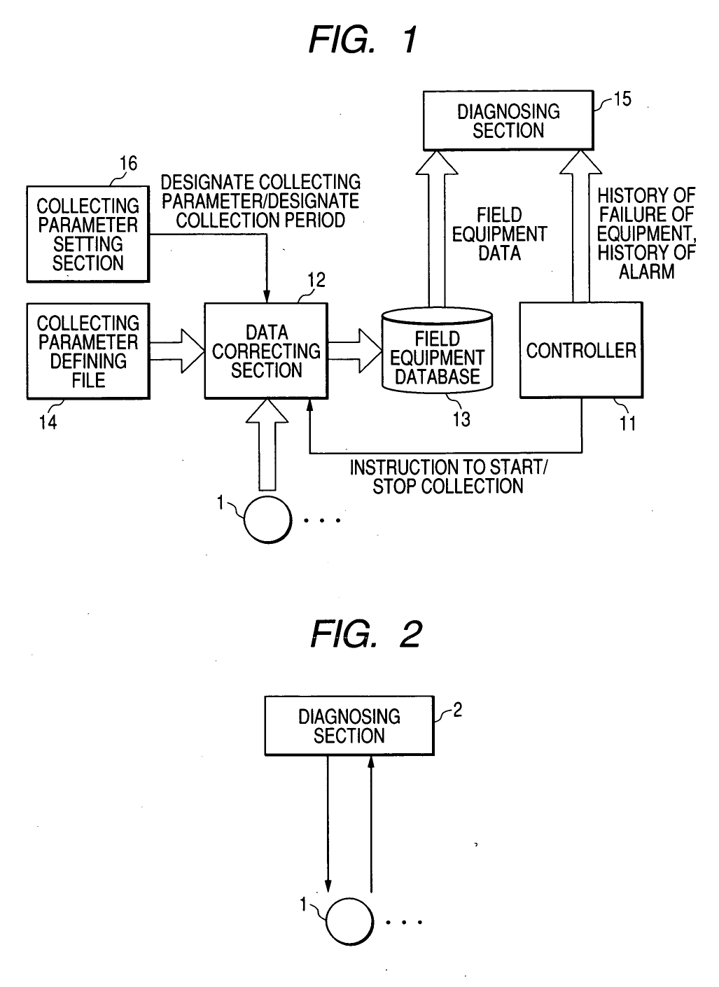

FIG. 1 is a configurative view showing an embodiment of the present invention. The same reference numerals are affixed to the same elements as those in the foregoing drawing.

At the time when the field equipment 1 is registered on a controller 11, the controller 11 instructs a data collecting section 12 to start collecting a parameter of the field equipment 1.

In this case, only the field equipment 1 is illustrated herein, but the number of the field equipments is not limited to one. Also, the number of the parameters to be collected, of the field equipment 1 is not limited to one.

After the instruction from the controller 11 to start collecting the parameter, the data collecting section 12 collects the parameter of the field equipment 1 continuously at a predetermined period. The collected parameter is stored in a field equipment database 13.

A storing section (not shown) provided in the system stores a collecting parameter defining file 14 which designates the parameter to be collected and is previously designated for every field equipment. The parameter to be collected by the data collecting section 12′ is set by reading the collecting parameter defining file 14.

The field equipment holds a number of parameters in the inside thereof. Among these parameters, parameters to be utilized in the future are designated previously by the collecting parameter defining file 14.

Here, the parameters of the field equipment are, for example, a total number of strokes of a valve positioner, a degree of contamination of an electrode of an electromagnetic flowmeter, temperatures of equipments not used for control, etc.

In a special condition such as during a removal of the field equipment 1 and during a shutdown of a connected segment, the controller 11 instructs the data collecting section 12 to stop the collection. Then, the collection of the parameter is stopped until the instruction to resume the collection is issued. Thus, useless parameter is not collected in the field equipment database 13.

A diagnosing section 15 acquires the parameter stored in the field equipment database 13 at the time of diagnosis of the field equipment 1.

Since the past parameter values of the field equipment 1 are stored in the field equipment database 13, a time dependent change of the parameter values can be obtained.

Accordingly, the present state of the field equipment can be grasped, and a failure prediction of the field equipment in the future, and the like can be carried out, based on the history of the parameter such as whether the parameter values is changed sharply, whether the parameter value is changed gradually, and whether the parameter value is changed periodically.

Also, based on a correlation of the parameter with a different parameter in the same field equipment or with a parameter in a different field equipment, the diagnosis and the management of the field equipment can be executed with higher reliability.

When a set value is given to the controller 11, the controller 11 controls the field equipment 1 so that a deviation of a measured value in the process as an object of control from the set value becomes zero. When the measured value is out of a certain range, and the like, the controller 11 detects a failure in the process and then outputs an alarm.

The diagnosing section 15 acquires a history of a failure of the field equipment 1 and a history of the alarm in the process from the controller 11, and then can diagnose and manage the field equipment 1 while correlating the acquired histories with the parameter stored in the field equipment database 13.

as a result, relationships between the change of the parameter values and the failures, etc. are accumulated, and in turn it is possible to diagnose and manage the field equipment 1 with high reliability.

The field equipment database 13 stores an equipment number and an equipment tag of the field equipment, in association with the parameter of the field equipment 1.

The equipment number is an identifier used to identify an individual of the field equipment and is the number peculiar to the field equipment. In contrast, the equipment tag is a logical identifier for the field equipment, and is allocated based on the role or the like of the field equipment. The same equipment tag can be allocated when the field equipment is replaced due to the failure or the like.

In the case where the field equipment is replaced due to the failure or the like, the diagnosing section 15, when diagnosing the field equipment 1, can select to handle the parameter of the field equipment before the replacement and the parameter of the field equipment after the replacement logically as the parameters from the same field equipments or from the different field equipments.

The parameter of the field equipment is changed due to various factors such as surrounding environment, time elapsed, production lot of the field equipment. Therefore, the parameter stored in the field equipment database 13 can be utilized effectively for every factor.

The parameter to be collected by the data collecting section 12 can be designated for every field equipment by a collecting parameter setting section 16. This parameter designation is effective when, based on the analysis result of the parameter stored in the field equipment database 13, which is analyzed by the diagnosing section 15, further another parameter is needed, or the like.

Also, the period to collect the parameter by the data collecting-section 12 can be designated for every parameter by the collecting parameter setting section 16. Since a capacity of the field equipment database 13 is finite, the field equipment database 13 can be used effectively by setting an appropriate parameter collection period for every parameter.

Also, this designation of the parameter collection period is effective, for example, in such a situation that when a specific tendency appears in the parameter values of the field equipment 1 in result of the diagnosis by the diagnosing section 15, the parameter collection period may be shortened in order to diagnose the field equipment 1 in more detail.

As apparent from the above explanation, following advantages can be achieved by the present invention.

Since the parameter of the designated field equipment is collected at a predetermined period continuously after the start of the collection is instructed, the past parameter values are analyzed as occasion demands, and a status of the field equipment can be analyzed.

Also, the collected parameters can be analyzed statistically and integrally with the history of the past failure of the same type field equipment, the history of the alarm in the process, and the like. Thus, the diagnosis of the field equipment can be realized with high reliability.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. A field equipment managing system comprising:
a field equipment;
a data collecting section for collecting a parameter of the field equipment at a predetermined period;
a field equipment database for storing the collected parameter; and
a diagnosing section for conducting a diagnosis of the field equipment by using the stored parameter.

2. The field equipment managing system according to claim 1, further comprising:
a controller for controlling the field equipment,
wherein the data collecting section starts collecting the parameter when the controller recognizes the field equipment.

3. The field equipment managing system according to claim 2, wherein the data collecting section stops collecting the parameter when the field equipment becomes unrecognized by the controller.

4. The field equipment managing system according to claim 1, further comprising:
a storing section for storing a collecting parameter defining file which designates the parameter to be collected,
wherein the data collecting section collects the parameter based on the collecting parameter defining file.

5. The field equipment managing system according to claim 1, further comprising:
a collecting parameter setting section,
wherein the collecting parameter setting section designates the parameter to be collected by the data collecting section, for every field equipment.

6. The field equipment managing system according to claim 1, further comprising:
a collecting parameter setting section,
wherein the collecting parameter setting section designates the period of collecting the parameter by the data collecting section, for every parameter.

7. The field equipment managing system according to claim 1, further comprising:
a controller for controlling the field equipment,
wherein the controller issues at least any one of an instruction to start collecting the parameter and an instruction to stop collecting the parameter, to the data collecting section.

8. The field equipment managing system according to claim 1, wherein the field equipment database stores an individual identifier of the field equipment and a logical identifier of the field equipment, in association with the parameter.

9. The field equipment managing system according to claim 1, wherein, when the field equipment is replaced with another field equipment, the diagnosing section selects to handle the parameter of the field equipment before the replacement and the parameter of the field equipment after the replacement as the parameters from the same field equipments or from the different field equipments.

10. The field equipment managing system according to claim 2, wherein the diagnosing section acquires at least any one of a history of a failure of the field equipment and a history of an alarm in a process from the controller, correlates the parameter stored in the field equipment database with the acquired history, and conducts the diagnosis of the field equipment based on the acquired history and the correlated parameter.

11. The field equipment managing system according to claim 10, wherein the diagnosing section conducts a failure prediction of the field equipment.
